(19) United States
(12) Patent Application Publication
(10) Pub. No.: US 2025/0079502 A1
(43) Pub. Date: Mar. 6, 2025

(54) ALL-SOLID- STATE BATTERY AND MANUFACTURING METHOD THEREOF

(71) Applicant: SAMSUNG ELECTRO-MECHANICS CO., LTD., Suwon-si, Gyeonggi-do (KR)

(72) Inventor: Kyunglock Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/294,006

(22) PCT Filed: Jan. 3, 2024
(86) PCT No.: PCT/KR2024/000144

§ 371 Date: Jan. 31, 2024

(30) Foreign Application Priority Data
Apr. 13, 2023 (KR) 10-2023-0048593

(51) Int. Cl. H01M 10/0562; H01M 4/04

(52) U.S. Cl. CPC H01M 10/0562; H01M 4/0433; H01M 4/0471; H01M 2300/0071

(57) ABSTRACT

An all-solid-state battery according to present disclosure includes a cell stack including a solid electrolyte layer, and a positive electrode layer and a negative electrode layer with the solid electrolyte layer disposed therebetween, and an outermost layer on one surface or both surfaces of the cell stack in a stacking direction, wherein the outermost layer includes an epoxy resin and glass particles and the glass particles include a boron (B) oxide, a silicon (Si) oxide, and an aluminum (Al) oxide.

### TECHNICAL FIELD

The present disclosure relates to an all-solid-state battery and a manufacturing method thereof.

### BACKGROUND ART

Recently, as portable electronic devices are required to be down-sized and used for a long term, high-capacity batteries are required, and safety of the batteries is also required due to the spread of wearable electronic devices. As conventional rechargeable lithium batteries use liquid electrolytes, they are easily ignited when exposed to water vapor in the air, and thus stability problems have always been raised. Accordingly, development of an all-solid-state battery using a solid electrolyte instead of a liquid electrolyte is actively progressing.

Since the all-solid-state battery does not use a flammable organic solvent, additional circuitry for safety may be simplified. In addition, the all-solid-state battery is attracting attentions as a next generation rechargeable battery in terms of stability, high energy density, high power, long cycle-life, simplification of manufacturing process, large-sizing, down-sizing, low-pricing, and the like. Herein, a co-firing method is required in manufacturing parallel multi-layer battery chips such as MLCC.

However, when an impregnation process of including the solid electrolyte in each electrode layer (positive and negative electrode layers) in the all-solid-state battery and a firing process of co-firing a stack of the electrodes and the solid electrolyte at a low temperature are performed, since voids and grains are generated in the electrode layers and cause high resistance, there is a problem of low lithium ionic conductivity. Furthermore, there is another problem of deteriorated adhesive strength due to different surface properties between an electrode active material in the electrode layers and the solid electrolyte.

### DISCLOSURE OF INVENTION

### Solution to Problem

One aspect of the embodiment provide an all-solid-state battery capable of co-firing at a low temperature, reducing the resistance between the electrode active material and the solid electrolyte in the electrode layer and significantly increasing an adhesive strength therebetween, reducing an interfacial resistance between the electrode layer and the solid electrolyte layer, and significantly increasing an adhesive strength between the layers, and thereby implementing high ionic conductivity and having high power performance.

Another aspect of the embodiment provides a method for manufacturing the all-solid-state battery.

However, problems to be solved by the embodiments am not limited to the above-described problems and may be variously expanded within the range of technical ideas included in the embodiments.

### Advantageous Effects of Invention

According to the all-solid-state battery according to the embodiment, while co-firing is enabled at a low temperature, the resistance between the electrode active material and the solid electrolyte in the electrode layer may be reduced and the adhesive strength therebetween may be significantly increased, the interfacial resistance between the electrode layer and the solid electrolyte layer may be reduced, and the adhesive strength between layers is significantly increased to realize high ionic conductivity and have high power performance.

However, the various advantageous advantages and effects of the present invention are not limited to the above descriptions, and will be more easily understood in the process of describing specific embodiments of the present invention.

### BRIEF DESCRIPTION OF DRAWINGS

FIG. 1 is a perspective view schematically illustrating an all-solid-state battery according to an embodiment.

FIG. 2 is a cross-sectional view of an all-solid-state battery according to an embodiment shown in FIG. 1.

FIG. 3 is a cross-sectional view of an all-solid-state battery according to another embodiment shown in FIG. 1.

FIG. 4 is a scanning electron microscope (SEM) photograph of a positive electrode layer formed in the cell stack of Example 1.

FIG. 5 is a scanning electron microscope (SEM) photograph of a negative electrode layer formed in the cell stack of Example 1.

FIG. 6 shows a graph obtained by analyzing the X-ray diffraction spectrum (XRD) using CuKα rays of the positive electrode layer of the cell stack manufactured in Example 1.

FIG. 7 shows a graph obtained by analyzing the X-ray diffraction spectrum (XRD) using CuKα rays of the negative electrode layer of the cell stack manufactured in Example 1.

FIG. 8 shows a scanning electron microscope (SEM) photograph of the positive electrode layer in the cell stack manufactured in Example 1.

FIG. 9 shows a scanning electron microscope (SEM) photograph of the positive electrode layer in the cell stack manufactured in Comparative Example 2.

FIG. 10 shows a scanning electron microscope (SEM) photograph of the positive electrode layer in the cell stack manufactured in Comparative Example 3.

FIG. 11 shows a scanning electron microscope (SEM) photograph of the positive electrode layer in the cell stack manufactured in Comparative Example 4.

FIG. 12 shows a scanning electron microscope (SEM) photograph of the positive electrode layer in the cell stack manufactured in Comparative Example 5.

FIG. 13 shows a scanning electron microscope (SEM) photograph of a positive electrode layer taken at 10K in the cell stack manufactured in Example 1.

FIG. 14 shows a scanning electron microscope (SEM) photograph of a positive electrode layer taken at 3K in the cell stack manufactured in Example 1.

FIG. 15 shows a scanning electron microscope (SEM) photograph of a positive electrode layer taken at 10K in the cell stack manufactured in Example 2.

FIG. 16 shows a scanning electron microscope (SEM) photograph of a positive electrode layer taken at 3K in the cell stack manufactured in Example 2.

FIG. 17 shows a scanning electron microscope (SEM) photograph of a positive electrode layer taken at 10K in the cell stack manufactured in Comparative Example 6.

FIG. 18 shows a scanning electron microscope (SEM) photograph of a positive electrode layer taken at 3K in the cell stack manufactured in Comparative Example 6.

FIG. 19 is a graph measuring lithium ionic conductivity of the positive electrode layer of the cell stack manufactured in Example 1.

FIG. 20 shows a scanning electron microscope (SEM) image of a solid electrolyte layer and a positive electrode layer, and a first solid electrolyte interface layer formed therebetween of an all-solid-state battery according to Example 1.

FIG. 21 is a photograph of analyzing the interfacial adhesive strength of the first solid electrolyte interface layer formed between the positive electrode layer and the solid electrolyte layer manufactured in Example 1.

FIG. 22 is a photograph of analyzing the interfacial adhesive strength of the first solid electrolyte interface layer formed between the positive electrode layer and the solid electrolyte layer prepared in Comparative Example 1.

FIG. 23 shows a transmission electron microscope (TEM) photograph of the positive electrode active material included in the positive electrode layer of the cell stack manufactured in Example 1.

FIG. 24 shows a transmission electron microscope (TEM) photograph of the positive electrode active material included in the positive electrode layer of the cell stack manufactured in Example 2.

FIG. 25 shows a transmission electron microscope (TEM) photograph of the positive electrode active material included in the positive electrode layer of the cell stack manufactured in Comparative Example 6.

### BEST MODE FOR CARRYING OUT THE INVENTION

An all-solid-state battery according to an embodiment includes a solid electrolyte layer; and a positive electrode layer and a negative electrode layer with the solid electrolyte layer disposed therebetween; wherein the positive electrode layer includes a positive electrode active material and a solid electrolyte, the negative electrode layer includes a negative electrode active material and a solid electrolyte, the positive electrode layer or the negative electrode layer includes an oxide of a sintering aid, and the solid electrolyte is an amorphous solid electrolyte including a Li (lithium) oxide, a Si (silicon) oxide, a B (boron) oxide, or a combination thereof.

The positive electrode layer may include the positive electrode active material, and a composite including the solid electrolyte and the oxide of the sintering aid on a surface of the positive electrode active material.

The negative electrode layer may include the negative electrode active material, and a composite including the solid electrolyte and the oxide of the sintering aid on a surface of the negative electrode active material.

The all-solid-state battery may further include a first solid electrolyte interface layer between the solid electrolyte layer and the positive electrode layer, or may further include a second solid electrolyte interface layer between the solid electrolyte layer and the negative electrode layer, and the first solid electrolyte interface layer or the second solid electrolyte interface layer may include an oxide of the sintering aid and the solid electrolyte.

The amorphous solid electrolyte may include Li₂O—SiO₂—B₂O₃.

The oxide of the sintering aid may include Li₂O (lithium oxide).

The oxide of the sintering aid included in one of the positive electrode layer or the negative electrode layer may be in an amount of 1 to 15 wt % based on the total amount of the one of the positive electrode layer or the negative electrode layer.

The positive electrode active material may include LiCoO₂.

The negative electrode active material may include graphite.

The solid electrolyte layer may further include the oxide of the sintering aid.

A method for manufacturing an all-solid-state battery according to another embodiment includes (1) preparing a positive electrode mixture of a positive electrode active material, a solid electrolyte, and a sintering aid, and a negative electrode mixture of a negative electrode active material, a solid electrolyte and a sintering aid; (2) molding the positive electrode mixture and negative electrode mixture to manufacture a positive electrode green sheet and a negative electrode green sheet; (3) sequentially stacking the positive electrode green sheet, a solid electrolyte green sheet, and the negative electrode green sheet to manufacture a stack; and (4) co-firing the stack at 450 to 500° C.

The solid electrolyte may be an amorphous solid electrolyte including a Li (lithium) oxide, a Si (silicon) oxide, a B (boron) oxide, or a combination thereof.

The amorphous solid electrolyte may include Li₂O—SiO₂—B₂O₃.

The sintering aid may include LiOH (lithium hydroxide).

The sintering aid included in one of the positive electrode layer or the negative electrode layer may be in an amount of 1 to 15 wt % based on the total weight of the one of the positive electrode mixture or the negative electrode mixture.

A density of the sintering aid may be 1.2 to 1.6 g/L.

A melting point of the sintering aid may be 450 to 500° C.

### MODE FOR THE INVENTION

Hereinafter, various embodiments of the present invention will be described in detail with reference to the accompanying drawings so that those skilled in the art may easily carry out the present invention. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present invention includes all modifications, equivalents, and substitutions without departing from the scope and spirit of the present invention. In addition, some constituent elements in the accompanying drawings are exaggerated, omitted, or schematically illustrated, and the size of each constituent element does not entirely reflect the actual size.

In addition, unless explicitly described to the contrary, the word “comprise”, and variations such as “comprises” or “comprising”, will be understood to imply the inclusion of stated elements but not the exclusion of any other elements.

Through the specification, the “stacking direction” refers to a direction in which constituent elements are sequentially stacked or the “thickness direction” perpendicular to the large surface (main surface) of the sheet-shaped constituent elements, which corresponds to a T-axis direction in the drawing. In addition, the “side direction” refers to a direction extending parallel to the large surface (main surface) from the edge of the sheet-shaped constituent elements or a “planar direction”, which corresponds to an L-axis direction in the drawing. Further, the W-axis direction in the drawing may be a “width direction”.

Throughout the specification, the positive electrode layer or negative electrode layer may be described as an electrode layer.

Throughout the specification, a positive electrode active material or negative electrode active material may be described as an electrode active material.

Throughout the specification, the positive electrode layer, the negative electrode layer, the solid electrolyte layer, and the solid electrolyte interface layer all include a solid electrolyte, and the solid electrolyte may be all of the same material.

Hereinafter, various embodiments and modifications will be described in detail with reference to the drawings.

### All-Solid-State Battery 100

An all-solid-state battery according to an embodiment includes a solid electrolyte layer, and a positive electrode layer and a negative electrode layer with the solid electrolyte layer disposed therebetween. The positive electrode layer includes a positive electrode active material and a solid electrolyte, the negative electrode layer includes a negative electrode active material and a solid electrolyte, the positive electrode layer or the negative electrode layer includes an oxide of the sintering aid, and the solid electrolyte is an amorphous solid electrolyte including a Li (lithium) oxide, a Si (silicon) oxide, a B (boron) oxide, or a combination thereof.

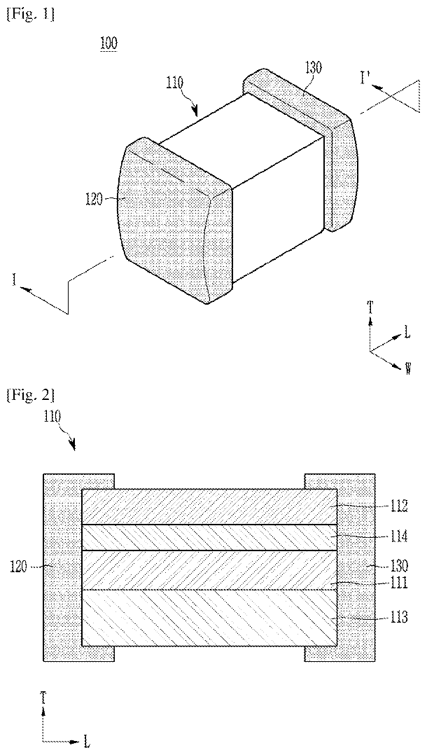

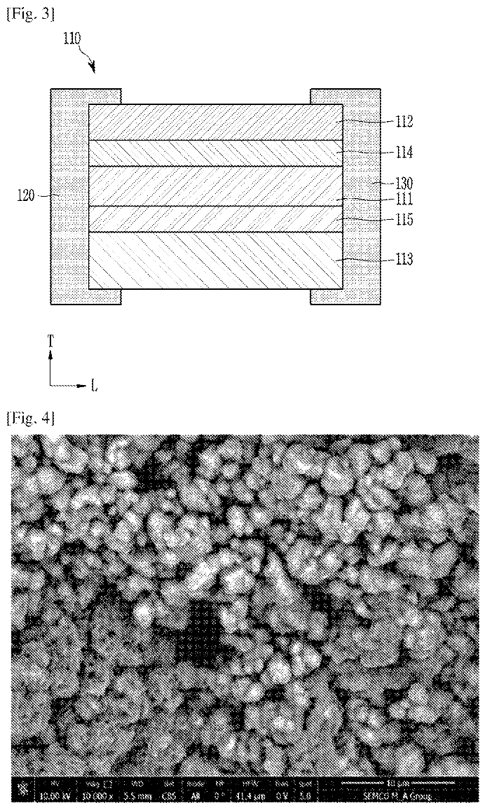

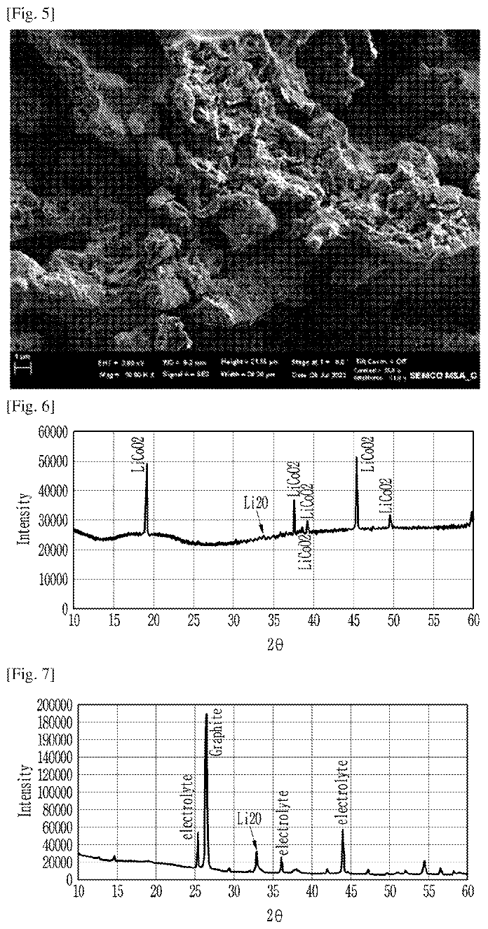

FIG. 1 is a perspective view schematically illustrating an all-solid-state battery according to an embodiment, FIG. 2 is a cross-sectional view of an all-solid-state battery according to an embodiment shown in FIG. 1, and FIG. 3 is a cross-sectional view of an all-solid-state battery according to another embodiment shown in FIG. 1.

The all-solid-state battery 100 may have, for example, an approximate hexahedral shape.

For example, the all-solid-state battery 100 includes a cell stack 110 including a solid electrolyte layer 111, and a positive electrode layer 112 and a negative electrode layer 113 with the solid electrolyte layer 111 disposed therebetween.

Referring to FIGS. 2 and 3, the all-solid-state battery 100 further includes a first solid electrolyte interface layer 114 disposed between the solid electrolyte layer and the positive electrode layer, or a second solid electrolyte interface layer 115 disposed between the solid electrolyte layer and the negative electrode layer.

Hereinafter, each layer included in the all-solid-state battery 100 will be described in detail.

### Solid Electrolyte Laver 111

The solid electrolyte layer 111 may be disposed and stacked between the positive electrode layer 112 and the negative electrode layer 113. In addition, solid electrolyte interface layers 114 and 115 formed in a low-temperature co-firing process may be further disposed on one surface or the other surface of the solid electrolyte layer 111.

The solid electrolyte layer 111 includes a solid electrolyte, and the solid electrolyte may include an oxide-based solid electrolyte.

The oxide-based solid electrolyte may be Garnet-type, NASICON-type, LISICON-type, perovskite-type, UPON-type, or amorphous (glass) electrolyte.

The garnet-based solid electrolyte may include lithium-lanthanum zirconium oxide (LLZO) represented by LiₐLa_{b}Zr_{c}O₁₂ such as Li₇La₃Zr₂O₁₂, and the NASICON-based solid electrolyte may include a lithium-aluminum-titanium-phosphate salt (LATP) of Li₁₊ₓAlₓTi₂₋ₓ(PO₄)₃(0<x<1) in which Ti is introduced into a Li₁₊ₓAlₓM₂₋ₓ(PO₄)₃ (LAMP) (0<x<2, M is Zr, Ti, or Ge) type compound, lithium-aluminum-germanium-phosphate (LAGP) represented by Li₁₊ₓAlₓGe₂₋ₓ(PO₄)₃(0<x<1) such as Li_{1.3}Al_{0.3}Ti_{1.7}PO₄)₃ introduced with excess lithium and/or lithium-zirconium-phosphate (LZP) of LiZr₂(PO₄)₃.

In addition, the LISICON-based solid electrolyte may be include a solid solution oxide represented by xLi₃AO₄-(1−x)Li₄LBO₄ (wherein A is P, As, or V and B is Si, Ge, or Ti) such as Li₄Zn(GeO₄)₄, Li₁₀GeP₂O₁₂(LGPO), Li_{3.5}Si_{0.5}P_{0.5}O₄, or Li_{10,42}Si(Ge)_{1.5}P_{1.5}C_{0.08}O₁₁₀₂ or a solid solution sulfide represented by Li₄₋ₓM_{1-y}M′_{y}S₄ (wherein M is Si, or Ge and M′ is P, Al, Zn, or Ga) such as Li₂S—P₂S₅, Li₂S—SiS₂, Li₂S—SiS₂—P₂S₅, or Li₂S—GeS₂.

The perovskite-based solid electrolyte may include lithium lanthanum titanate (LLTO) represented by Li₃ₓLa_{2/3-x1/3-2x}TiO₃ (0<x<0.16) such as Li_{1/8}La_{5/8}TiO₃. The LiPON-based solid electrolyte may include a lithium phosphorous oxynitride such as Li_{2.8}PO_{3.3}N_{0.46}.

In an embodiment, the solid electrolyte may be an amorphous solid electrolyte. The amorphous solid electrolyte is an electrolyte in a glass state, wherein the glass means that it is crystallographically amorphous, which is confirmed by a halo observed in an X-ray diffraction or an electron beam diffraction, etc.

When the amorphous solid electrolyte is used, the amorphous solid electrolyte, which should be fired at a low temperature, may be simultaneously softened with a sintering aid softened at the low temperature (e.g., about 500° C. or less) and thus form a composite with an oxide of the sintering aid.

On the contrary, in addition to the amorphous solid electrolyte, a glass-ceramic-based solid electrolyte should be fired at a high temperature (e.g., about 600° C. or more, or 800° C. or more, or 1000° C. or more) and thus is difficult to simultaneously fire with the sintering aid during the low temperature firing, failing in realizing an all-solid-state battery having high ionic conductivity. For reference, the glass-ceramic (or, crystallized glass) means that amorphous and crystalline are crystallographically mixed, which is confirmed by a peak and a halo observed in an X-ray diffraction or an electron beam diffraction, etc.

For example, the solid electrolyte is an amorphous solid electrolyte including a Li (lithium) oxide, a Si (silicon) oxide, a B (boron) oxide, a P (phosphorus) oxide, a Li (lithium) salt, or a combination thereof. Specifically, the amorphous solid electrolyte may include Li (lithium) oxide, Si (silicon) oxide, B (boron) oxide, or a combination thereof.

For example, the solid electrolyte may be an amorphous solid electrolyte including Li₂O, SiO₂B₂O₃, P₂O₅, Li₃BO₃ or a combination thereof. For example, the amorphous solid electrolyte may include Li₂O—SiO₂—B₂O₃ or Li₂O—B₂O₃—P₂O₅, and more specifically. Li₂O—SiO₂—B₂O₃.

For reference, the Li₂O included in the amorphous solid electrolyte is distinguished from Li₂O included in the oxide of the sintering aid described later. Specifically. Li₂O included in the amorphous solid electrolyte is amorphous in which halo is observed in X-ray diffraction or electron diffraction, while Li₂O included in the oxide of the sintering aid corresponds to a crystallinity in which a peak is observed in X-ray diffraction or electron diffraction.

In addition, the solid electrolyte layer 111 may further include an oxide of a sintering aid produced in a low-temperature co-firing process. The oxide of the sintering aid will be described later.

### Positive Electrode Layer 112

The positive electrode layer 112 includes a positive electrode active material, a solid electrolyte, and an oxide of a sintering aid. For example, the positive electrode layer may include a positive electrode active material, and a composite including a solid electrolyte and an oxide of a sintering aid on the surface of the positive electrode active material. As a more specific example, the positive electrode layer may include particles of a positive electrode active material in the form of particles, an oxide of a sintering aid on the surface of the positive electrode active material, and a solid electrolyte on the surface of the oxide of the sintering aid.

According to the manufacturing method of an all-solid-state battery described later, the positive electrode layer may be manufactured by firing a positive electrode mixture in which a positive electrode active material, a solid electrolyte, and a sintering aid are mixed. During the firing process, the sintering aid is oxidized to generate an oxide of the sintering aid, which may be disposed on the surface of the positive electrode active material while forming a composite with the softened solid electrolyte. Accordingly, since the resistance between the positive electrode active material and the solid electrolyte is low and mutual adhesive strength is improved, pores or grains in the positive electrode layer are significantly reduced, the resistance in the positive electrode layer is low, and thus high ionic conductivity can be realized.

The positive electrode active material is not particularly limited as long as it can secure sufficient capacity of the all-solid-state battery 100. For example, positive electrode active material may include lithium cobalt oxide, lithium nickel cobalt manganese oxide, lithium nickel cobalt aluminum oxide, lithium iron phosphate, lithium manganese oxide, or a combination thereof.

For example, the positive electrode active material may be compounds represented by the following chemical formulas: LiₐA_{1-b}M_{b}D₂ (wherein 0.905≤a≤1.8, 0≤b≤0.5); LiₐE_{1-b}M_{b}O_{2-c}D_{c} (wherein 0.90≤a≤1.8, 0≤b≤0.5, 0≤c≤0.05); LiE_{1-b}M_{b}O_{z,999} D_{c} (wherein 0≤b≤0.5, 0≤c≤0.05); LiₐNi [symbol] Co_{b}M₂Dₐ (wherein 0.90≤a≤1.8, 0≤b≤0.5, 0≤c≤0.05, 0<α≤2); LiaNi [symbol] Co_{b}M [symbol] O_{2-α}X_{α} (wherein 0.90≤a≤1.8, 0≤b≤0.5, 0≤c≤0.05, 0<α<2); Liₐ Ni [symbol] CO_{b}M_{c}O_{2-α}X₂ (wherein 0.90≤a≤1.8, 0≤b≤0.5, 0≤c≤0.05, 0<α<2); LiₐNi [symbol] Mn_{b}M_{c}D_{α} (wherein 0.90≤a≤1.8, 0≤b≤0.5, 0≤c≤0.05, 0<α≤2); LiₐNi [symbol] Mn_{b}M_{c}O_{2-α}X_{α} (wherein 0.90≤a≤1.8, 0≤b≤0.5, 0≤c≤0.05, 0<α<2); Li_{α}Ni [symbol] Mn_{b}M_{c}O_{2-α}X₂ (wherein 0.90≤a≤1.8, 0≤b≤0.5, 0≤c≤0.05, 0<α<2); LiₐNi_{b}E_{c}G_{d}O₂ (wherein 0.90≤a≤1.8, 0≤b≤0.9, 0≤c≤0.5, 0.001≤d≤0.1); LiₐNi_{b}Co_{c}Mn [symbol] GeO₂ (wherein 0.90≤a≤1.8, 0≤b≤0.9, 0≤c≤0.5, 0≤d≤0.5, 0.001≤e≤0.1); Li [symbol] NiGbO₂ (wherein 0.90≤a≤1.8, 0.001≤b≤0.1); LiₐCoGbO₂ (wherein 0.90≤a≤1.8, 0.001≤b≤0.1); LiₐMnGbO₂ (wherein 0.90≤a≤1.8, 0.001≤b≤0.1); LiₐMn₂GbO₄ (wherein 0.90≤a≤1.8, 0.001≤b≤0.1); QO₂; QS₂; LiQS₂; V₂O [symbol] ; LiV₂O₂; LiRO₂; LiNiVO₄; Li [symbol] J₂(PO₄)₃ (0≤f≤2); Li [symbol] Fe₂(PO₄)₃ (wherein 0≤f≤2); and LiFePO₄, wherein in the above chemical formulas, A is Ni, Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fe, Sc, or Y; and J is V, Cr, Mn, Co, Ni, or Cu.

The positive electrode active material may also be LiCoO₂(LCO), LiMnₓO₂ₓ(wherein x=1 or 2), LiNi₁₋ₓMnₓO₂ₓ (wherein 0<x<1), LiNi [symbol] CoₓMn_{y}O₂ (wherein 0≤x≤0.5, 0≤y≤0.5), LiFePO₄, TiS₂, FeS₂, TiS₃, or FeS₃.

The solid electrolyte included in the positive electrode layer 112 is the same as the amorphous solid electrolyte included in the solid electrolyte layer 111. Since the amorphous solid electrolyte has been described in detail, the description is omitted herein.

The solid electrolyte may be included in an amount of 5 to 50 wt %, for example 5 to 30 wt %, or 10 to 50 wt %, or 10 to 30 wt % based on the total weight of the positive electrode layer.

The oxide of the sintering aid may be a material produced by oxidation of the sintering aid during the firing process. The oxide of the sintering aid may include Li₂O (lithium oxide).

The oxide of the sintering aid may be included in an amount of 1 to 15 wt %, for example 3 to 15 wt % based on the total weight of the positive electrode layer.

In addition, the positive electrode layer 112 may optionally further include an additive such as a binder or a conductive agent.

The conductive agent is not particularly limited as long as it has conductivity without causing chemical change in the all-solid-state battery 100. For example, examples of the conductive agent may include graphite such as natural graphite and artificial graphite; carbon-based substances such as carbon black, acetylene black, ketjen black, channel black, furnace black, lamp black, and summer black; conductive fibers such as carbon fibers and metal fibers; fluorinated carbon; metal powders such as aluminum and nickel powder; conductive whiskers such as zinc oxide and potassium titanate; conductive metal oxides such as titanium oxide; or conductive materials such as polyphenylene derivatives.

The binder may be used to improve bonding strength between an active material and a conductive agent. The binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene terpolymer (EPDM), sulfonated EPDM, a styrene butadiene rubber, a fluororubber, or various copolymers, and the like.

### Negative Electrode Layer 113

The negative electrode layer 113 may include a negative electrode active material, a solid electrolyte, and an oxide of a sintering aid. For example, the negative electrode layer may include a negative electrode active material, and a composite including a solid electrolyte and an oxide of a sintering aid on the surface of the negative electrode active material. As a more specific example, the negative electrode layer may include negative electrode active material particles in the form of particles, an oxide of a sintering aid on the surface of the negative electrode active material, and a solid electrolyte on the surface of the oxide of the sintering aid.

As described above in the positive electrode layer, in the negative electrode layer, the sintering aid is oxidized during the firing process to produce an oxide of the sintering aid, which forms a composite with the softened solid electrolyte and is disposed on the surface of the negative electrode active material, thereby significantly reducing pores or grains in the negative electrode layer and lowering resistance in the negative electrode layer to realize high ionic conductivity.

The negative electrode active material may be a carbon-based material, silicon, a silicon oxide, a silicon-based alloy, a silicon-carbon-based material composite, tin, a tin-based alloy, a tin-carbon composite, a metal oxide, or a combination thereof, and may include a lithium metal and/or a lithium metal alloy.

The lithium metal alloy may include lithium and a metal/semi-metal capable of alloying with lithium. For example, the metal/semi-metal capable of alloying with lithium may include Si, Sn, Al, Ge, Pb, Bi, Sb, a Si—Y alloy (wherein Y is an alkali metal, an alkaline-earth metal, Group 13 to Group 16 elements, a transition metal, a rare earth element, or a combination thereof, and Si is not included), a Sn—Y alloy (wherein Y is an alkali metal, an alkaline earth metal, Group 13 to Group 16 elements, a transition metal, a transition metal oxide such as lithium titanium oxide (Li₄Ti₅O₁₂), a rare earth element, or a combination thereof, and Sn is not included), or MₙOₓ (0<x≤2).

The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

In addition, the oxide of a metal/semi-metal capable of alloying with lithium may be lithium titanium oxide, vanadium oxide, lithium vanadium oxide, SnO₂, SiOₓ (0<x<2), and the like. For example, the negative electrode active material may include one or more elements selected from elements of Groups 13 to 16 of the periodic table of elements. For example, the negative electrode active material may include one or more elements selected from the group consisting of Si, Ge, and Sn.

The carbon-based material may be crystalline carbon, amorphous carbon, or a mixture thereof. The crystalline carbon may include graphite, such as natural graphite or artificial graphite in irregular, plate, flake, spherical, or fibrous form. In addition, the amorphous carbon may include soft carbon (low temperature calcined carbon) or hard carbon, a mesophase pitch carbonization product, calcined coke, graphene, carbon black, fullerene soot, a carbon nanotube, a carbon fiber, and the like.

The silicon may be Si, SiOₓ (0<x<2, for example 0.5 to 1.5), Sn, SnO₂, a silicon-containing metal alloy, or a mixture thereof. The silicon-containing metal alloy may include, for example, silicon and one or more of Al, Sn, Ag, Fe, Bi, Mg, Zn, In, Ge, Pb, and Ti.

The solid electrolyte included in the negative electrode layer 113 is the same as the amorphous solid electrolyte included in the solid electrolyte layer 111. Since the amorphous solid electrolyte has been described in detail, the description is omitted herein.

The solid electrolyte may be included in an amount of 5 to 50 wt %, for example 5 to 30 wt %, or 10 to 50 wt %, or 10 to 30 wt % based on the total weight of the negative electrode layer.

The oxide of the sintering aid may be a material produced by oxidation of the sintering aid during the firing process. The oxide of the sintering aid may include Li₂O (lithium oxide).

The oxide of the sintering aid may be included in an amount of 1 to 15 wt %, for example 3 to 15 wt %, based on the total weight of the negative electrode layer.

The negative electrode layer may also optionally include a conductive agent and a binder as described in the positive electrode layer. A detailed description is omitted herein.

### Solid Electrolyte Interface Layers 114 and 115

The solid electrolyte interface layers 114 and 115 are layers produced in a low-temperature co-firing process, and may be disposed between the solid electrolyte layer and a positive electrode layer, a negative electrode layer, or both of them.

For example, the all-solid-state battery 100 further includes a first solid electrolyte interface layer 114 between the solid electrolyte layer 111 and the positive electrode layer 112, or a second solid electrolyte interface layer 115 disposed between the solid electrolyte layer 11 and the negative electrode layer 113.

The solid electrolyte layer 111 has solid electrolyte interface layers 114 and 115 including a composite including an oxide of a sintering aid and an amorphous solid electrolyte disposed on one or the other surface, thereby achieving high lithium ionic conductivity even after co-firing at a low temperature.

When stacking the positive electrode layer, solid electrolyte layer, and negative electrode layer and co-firing the same at a low temperature, the solid electrolyte interface layers 114 and 115 are layers formed at the interface between the electrode layer and the solid electrolyte layer by simultaneously oxidizing and softening (melting) the sintering aid and the amorphous solid electrolyte included in each electrode layer (positive electrode layer and negative electrode layer) at the peak of the sintering temperature to interconnect the resultant. Specifically, the solid electrolyte interface layer is a layer formed by oxidizing a sintering aid during co-firing to produce an oxide of the sintering aid, which form, a composite with a softened amorphous solid electrolyte to have a SE. (Solid Electrolyte Interface) structure. Accordingly, high ionic conductivity at room temperature may be implemented.

The solid electrolyte interface layers 114 and 115 may include an oxide of a sintering aid and a solid electrolyte.

The oxide of the sintering aid may be a material produced by oxidation of the sintering aid during the firing process. The oxide of the sintering aid may include Li₂O (lithium oxide).

The oxide of the sintering aid may be included in an amount of 1 to 15 wt %, for example, 3 to 15 wt %, or 5 to 15 wt %, based on the total weight of the solid electrolyte interface layer. When included in less than 1 wt %, the strength of the solid electrolyte interface layer may be low, and when included in more than 15 wt %, ionic conductivity may be deteriorated.

The solid electrolyte included in the solid electrolyte interface layers 114 and 115 is the same as the amorphous solid electrolyte included in the solid electrolyte layer 111. The amorphous solid electrolyte has already been described in detail and will not be repeatedly mentioned.

The solid electrolyte interface layers 114 and 115 may have an average thickness of 0.5 to 5.0 μm. When the solid electrolyte interface layers have an average thickness of 0.5 μm or less, there may be a problem of strength deterioration due to a decrease in adhesive strength between electrode particles and electrolyte, but when greater than 5.0 μm, ionic conductivity performance may be deteriorated. The average thickness of the solid electrolyte interface layers 114 and 115 may be measured in the following method. First of all, a cross-section of the solid electrolyte interface layers 114 and 115 is prepared through ion milling and the like and then, taken a photograph of with a scanning electron microscope (SEM). Subsequently, in the cross-section SEM photograph, ten points are randomly selected, and after measuring a thickness of the solid electrolyte interface layers 114 and 115 at each point, the measurements are calculated in an arithmetic mean as the average thickness of the solid electrolyte interface layers 114 and 115.

The all-solid-state battery 100 according to an embodiment includes a solid electrolyte layer, a positive electrode layer, a negative electrode layer, or a solid electrolyte interface layer disposed between the solid electrolyte layer and a positive electrode layer, a negative electrode layer, or both of them and has advantages of reducing interfacial resistance between the electrode layers and the solid electrolyte layer after low-temperature co-firing of the cell stack but increasing adhesive strength and thus realizing high ionic conductivity.

### Margin Layer and Protective Laver

A margin layer (not shown) may be disposed along edges of the positive electrode layer 112 and the negative electrode layer 113. The margin layer is disposed on the solid electrolyte layer 111 and may be disposed laterally adjacent to edges of the positive electrode layer 112 and the negative electrode layer 113. Accordingly, the margin layer may be disposed on the same layer in the positive electrode layer 112 and the negative electrode layer 113, respectively.

The margin layer may include an insulating material having an ionic conductivity of less than or equal to 1.0λ10⁻¹⁰ S/cm, for example, an insulating material such as the aforementioned solid electrolyte material, or resin.

For example, the insulating material may be a polyolefin such as polyethylene or polypropylene and the like, a polyester such as polyethylene terephthalate (PET) and the like, polyurethane, or polyimide.

Also, the margin layer may include an inorganic solid electrolyte including an oxide-based solid electrolyte, a sulfide-based solid electrolyte, or a combination thereof. However, the margin layer is not limited thereto but may include various materials.

A protective layer (not shown) made of an insulating material may be formed on the upper and lower ends of the cell stack 110 of the all-solid-state battery 100. An insulating material included in the protective layer may be the same as an insulating material included in the margin layer.

### External Electrodes 120 and 130

Also, referring to FIG. 1, external electrodes 120 and 130 are connected to both side surfaces of the cell stack of the all-solid-state battery 100, so that they can be configured to have positive or negative electrode properties.

The external electrodes 120 and 130 may include a conductive metal and glass.

The conductive metal may include, for example, copper (Cu), nickel (Ni), tin (Sn), palladium (Pd), platinum (Pt), gold (Au), silver (Ag), tungsten (W), titanium (Ti), lead (Pb), or an alloy thereof.

A glass component included in the external electrodes 120 and 130 may have a composition in which an oxide is mixed. The glass component may include, for example, a silicon oxide, a boron oxide, an aluminum oxide, a transition metal oxide, an alkali metal oxide, an alkaline-earth metal oxide, or a combination thereof. Herein, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba).

A method of forming the external electrodes 120 and 130 is not particularly limited. For example, the method may include dipping the cell stack in a conductive paste including a conductive metal and glass or screen-printing or gravure-printing the conductive paste on the surface of the cell stack. In addition, various methods of applying the conductive paste on the surface of the cell stack or transferring a dry film obtained by drying the conductive paste onto the cell stack may be used.

### Method of Manufacturing All-Solid-State Battery

The method for manufacturing an all-solid-state battery according to an embodiment includes (1) preparing a positive electrode mixture of a positive electrode active material, a solid electrolyte, and a sintering aid, and a negative electrode mixture of a negative electrode active material, a solid electrolyte, and a sintering aid; (2) manufacturing a positive electrode green sheet and a negative electrode green sheet by molding the positive electrode mixture and the negative electrode mixture; (3) sequentially stacking the positive electrode green sheet, the solid electrolyte green sheet, and the negative electrode green sheet; and (4) co-firing the stack at 450 to 500° C. The solid electrolyte may be an amorphous solid electrolyte including a Li (lithium) oxide, a Si (silicon) oxide, a B (boron) oxide, or a combination thereof.

In the step (1), the sintering aid is a material added to adjust the process temperature to a low temperature in the co-firing process. The sintering aid may be a lithium compound, for example LiOH (lithium hydroxide).

A melting point (mp) of the sintering aid may be 450 to 500° C. When the above numerical range is satisfied, the melting point of the sintering aid is similar to the softening temperature Tₛ of the amorphous solid electrolyte, so that when the amorphous solid electrolyte is softened in the low-temperature co-firing process, it is oxidized together to form a composite to significantly reduce an interfacial resistance.

A density of the sintering aid may be 1.2 to 1.6 g/L When the above numerical range is satisfied, interfacial adhesive strength can be remarkably improved because it has interface energy similar to that of an amorphous solid electrolyte.

The sintering aid may be included in an amount of 1 to 15 wt %, for example, 3 to 15 wt %, based on the total weight of the positive electrode mixture or the negative electrode mixture. When the content of the sintering aid is less than 1 wt %, the effect of reducing interfacial resistance and increasing adhesive strength is insignificant, and when the content of the sintering aid exceeds 15 wt %, over-agglomeration occurs in a local area and it can be difficult to achieve desired effects.

As a method of mixing the electrode active material, the solid electrolyte, and the sintering aid in step (1), a solid-phase method by ball milling, a wet method by liquid-phase mixing, a supporting method, or the like may be used, but the present disclosure is not limited thereto.

As the molding method of step (2), hot press, casting, extruding, etc. may be used, but the present disclosure is not limited thereto.

The step (4) may be performed at 450 to 500° C. for 0.5 to 3 hours.

In addition, the all-solid-state battery 100 may be manufactured as follows: a plurality of positive electrode layers 112 and negative electrode layers 113 are alternately stacked, and a plurality of solid electrolyte layers 111 are disposed therebetween to manufacture a cell stack, and the cell stack is subjected to batch firing. In this case, a plurality of solid electrolyte interface layers 114 and 115 may be formed between the plurality of electrode layers 112 and 113 and the plurality of solid electrolyte layers 111.

Hereinafter, specific examples of the invention are presented. However, the examples described below are only intended to specifically illustrate or explain the invention, and the scope of the invention should not be limited thereto.

### EXAMPLES

### Example 1

A positive electrode mixture including 70 wt % of a positive electrode active material, LiCoO₂, 20 wt % of an amorphous solid electrolyte, Li₂O—SiO₂—B₂O₃, and 10 wt % of a sintering aid, LiOH, is prepared by weighing each material, putting all the materials in a ceramic container, and uniformly mixing them for about 1 hour with a physically-inducing and magnetic stirring device.

A negative electrode mixture including 70 wt % of a negative electrode active material, graphite, 20 wt % of an amorphous solid electrolyte. Li₂O—SiO₂—B₂O₃, and 10 wt % of a sintering aid, LiOH, is prepared in the same manner as in the method of preparing the positive electrode mixture.

The positive electrode mixture and the negative electrode mixture are respectively taken by 0.3 g, placed in a circular die with a diameter of 14 pi, and pressed at about 1 ton, preparing a positive electrode green sheet and a negative electrode green sheet.

The positive electrode green sheet, a solid electrolyte layer pellet of Li₂O—SiO₂—B₂O₃, and the negative electrode green sheet are sequentially stacked and then, simultaneously fired at 475° C. for 3 hours, manufacturing a cell stack for an all-solid-state battery including positive and negative electrode layers including an oxide of the sintering aid, Li₂O. Herein, in the manufactured cell stack, a first solid electrolyte interface layer and a second solid electrolyte interface layer are formed through the firing.

### Example 2

A cell stack is manufactured in the same manner as in Example 1 except that the content of LiOH as a sintering aid is changed into 15 wt %.

### Comparative Example 1

A cell stack is manufactured in the same manner as in Example 1 except that the sintering aid is not included in the positive and negative electrode mixtures.

### Comparative Example 2

A cell stack is manufactured in the same manner as in Example 1 except that LIC-GC (Lithium-Ion Conducting Glass-Ceramics, Ohara Inc. Japan) is used as a type of solid electrolyte (meaning all the solid electrolytes included in the positive electrode mixture, the negative electrode mixture, and the solid electrolyte layer). The LIC-GC corresponds to a type of glass-ceramics-based solid electrolyte in which amorphous and crystalline are mixed.

### Comparative Example 3

A cell stack is manufactured in the same manner as in Example 1 except that Li₂O is used as a type of sintering aid.

### Comparative Example 4

A cell stack is manufactured in the same manner as in Example 1 except that B₂O₃ is used as a type of sintering aid.

### Comparative Example 5

A cell stack is manufactured in the same manner as in Example 1 except that Bi₂O₃ is used as a type of sintering aid.

### Comparative Example 6

A cell stack is manufactured in the same manner as in Example 1 except that the content of LiOH is changed into 20 wt % in the positive and negative electrode mixtures.

Characteristics (type, density, melting point, content) of sintering aids and solid electrolytes used in Examples 1 to 2 and Comparative Examples 1 to 6 and oxides of the sintering aids are shown in Table 1.

TABLE 1

| | Sintering aid | | | | | |
|---|---|---|---|---|---|---|
| | | | Melting | | | Oxide of |
| | | Density | point | Content | Solid | sintering |
| | Type | (g/L) | (° C.) | (wt %) | electrolyte | aid |
| Ex. 1 | LiOH | 1.46 | 462 | 10 | Li₂O—SiO₂— | Li₂O |
| | | | | | B₂O₃ | |
| Ex. 2 | LiOH | 1.46 | 462 | 15 | Li₂O—SiO₂— | Li₂O |
| | | | | | B₂O₃ | |
| Comp. | — | — | | — | Li₂O—SiO₂— | — |
| Ex. 1 | | | | | B₂O₃ | |
| Comp. | LiOH | 1.46 | 462 | 10 | LIC—GC | Li₂O |
| Ex. 2 | | | | | | |
| Comp. | Li₂O | 2.013 | 1438 | 10 | Li₂O—SiO₂— | — |
| Ex. 3 | | | | | B₂O₃ | |
| Comp. | B₂O₃ | 2.55 | 450 | 10 | Li₂O—SiO₂— | — |
| Ex. 4 | | | | | B₂O₃ | |
| Comp. | Bi₂O₃ | 8.9 | 817 | 10 | Li₂O—SiO₂— | — |
| Ex. 5 | | | | | B₂O₃ | |
| Comp. | LiOH | 1.46 | 462 | 20 | Li₂O—SiO₂— | Li₂O |
| Ex. 6 | | | | | B₂O₃ | |

### EXPERIMENTAL EXAMPLES

### Experimental Example 1: XRD Analysis

The positive and negative electrode layers formed in the cell stack of Example 1 are measured with respect to a diffraction angle (2θ) in an X-ray diffraction analysis spectrum (XRD) using CuKα ray. The measurement is performed under the following conditions.
Energy: 100 keV
Wavelength: 1.5418 Å
Detector: PANalytical X'Pert Pro Multipurpose Diffractometer with Cu Kα-radiation
Exposure time: 30 minutes
Temperature conditions: room temperature of 25° C.
Scattering angle: 10° to 60°

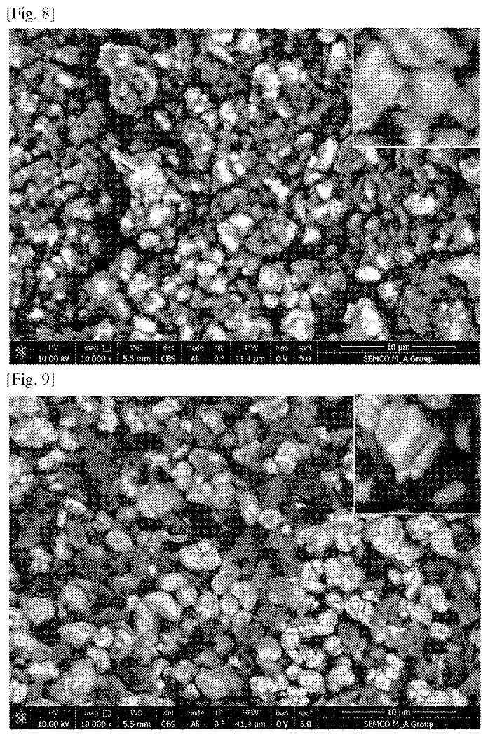

XRD graphs of the positive and negative electrode layers are measured under the above conditions and respectively shown in FIGS. 6 and 7.

Referring to FIGS. 6 and 7, when checked with Li₂O signals within a range of 32° to 34°, the positive and negative electrode layers including an oxide of the sintering aid are formed.

### Experimental Example 2: SEM Analysis

Scanning electron microscope (SEM) photographs of the positive and negative electrode layers of the cell stack according to Example 1 are shown in FIGS. 4 and 5. Referring to FIGS. 4 and 5, the positive and negative electrode layers include the oxide of the sintering aid to interconnect electrode active materials with the solid electrolyte, generating relatively few pores and grains.

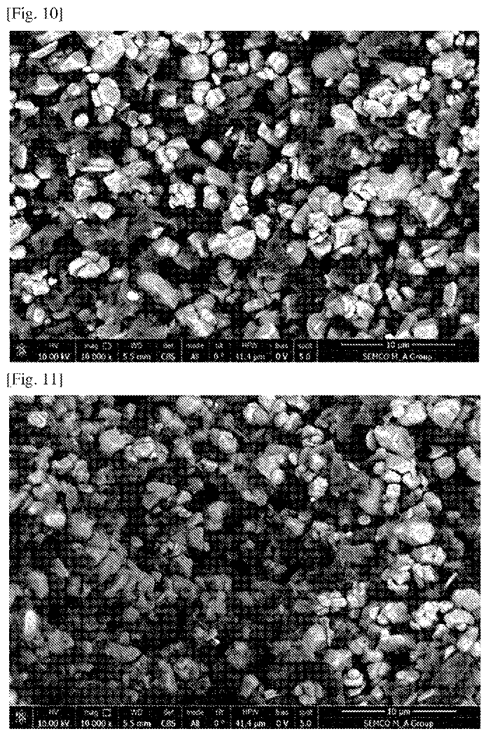

In the cell stacks of Example 1 and Comparative Example 2, scanning electron microscope (SEM) photographs of each positive electrode layer are shown in FIGS. 8 and 9. Referring to FIG. 8, Example 1, in which the oxide of the sintering aid is included in the positive electrode layer, exhibits that grains are relatively less produced due to improved adhesive strength of the positive electrode active material and the solid electrolyte in the positive electrode layer.

On the other hand, when LIC-GC, which can be fired only at a high temperature of 700° C. or higher, unlike an amorphous solid electrolyte, is used as a solid electrolyte as in Comparative Example 2, the solid electrolyte is not simultaneously softened at the same time as the sintering aid at 475° C. Accordingly, since the positive electrode layer includes no oxide of the sintering aid, referring to FIG. 9, relatively large voids and grains are generated in the positive electrode layer.

In the cell stacks of Comparative Examples 3, 4, and 5, scanning electron microscope (SEM) photographs of the positive electrode layers air sequentially shown in FIGS. 10 to 12.

Since Comparative Examples 3 and 5 use a sintering aid with a melting point of greater than 500° C., the sintering aid is not softened at a low temperature of 500° C., failing in connecting the positive electrode active material and the solid electrolyte. Accordingly, referring to FIGS. 10 and 12, relatively large pores and grains are generated in the positive electrode layers.

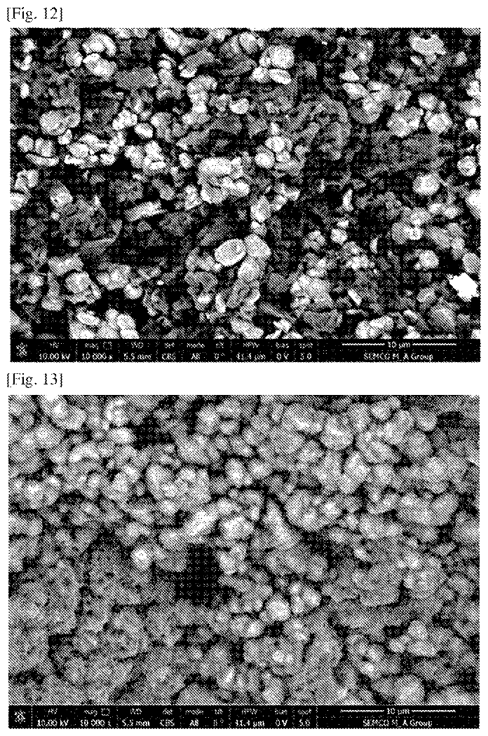

Comparative Example 4 uses a sintering aid with density of greater than 1.6 g/L, which has no similar interface energy to that of an amorphous solid electrolyte, deteriorating interfacial adhesive strength between positive electrode active material and solid electrolyte. Accordingly, referring to FIG. 11, relatively large voids and grains are generated in the positive electrode layer.

### Reference Example: Corresponds to the Supplementary Examples of Experimental Example 2

Regarding types of a sintering aid, whether or not other materials used as a sintering aid may achieve the effect of the present invention will be described with reference to Table 2.

Referring to Table 2, sintering aids such as Li₂O, SiO₂, and Bi₂O₃ having a melting point of greater than 500° C. are not softened at a low temperature of 500° C., failing in connecting a positive electrode active material and a solid electrolyte.

H₃BO₃, P₃O₄, and having a boiling point of less than 450° C. are impossible to calcinate at a temperature of 450 to 500° C.

A sintering aid having density of 1.6 g/L, or higher such as B₂O₃, even if fired at the low temperature, exhibit % deteriorated interfacial adhesive strength between positive electrode active material and solid electrolyte.

TABLE 2

| | | mp | bp | |
|---|---|---|---|---|
| Sintering | | (melting | (boiling | |
| aid | Density | point) | point) | remarks |
| LiOH | 1.46 | 462 | 924 | |
| Li₂O | 2.013 | 1438 | 2600 | High temperature firing |
| | | | | is not possible |
| B₂O₃ | 2.55 | 450 | 1860 | no effect |
| H₃BO₃ | 1.44 | 171 | 300 | Low temperature calcinating |
| | | | | is not possible |
| SiO₂ | 2.65 | 1713 | 2950 | High temperature firing |
| | | | | is not possible |
| Bi₂O₃ | 8.9 | 817 | 1890 | High temperature firing |
| | | | | is not possible |
| P₂O₅ | 2.39 | 340 | 360 | Low temperature calcinating |
| | | | | is not possible |
| H₃PO₄ | 1.88 | 42 | 158 | Low temperature calcinating |
| | | | | is not possible |

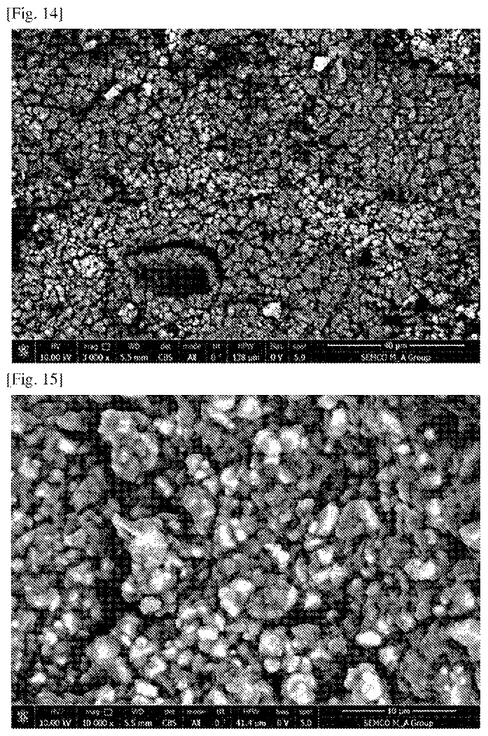

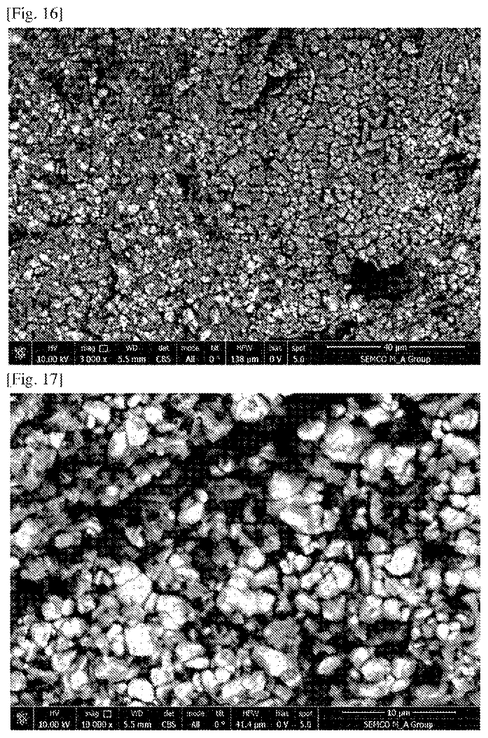

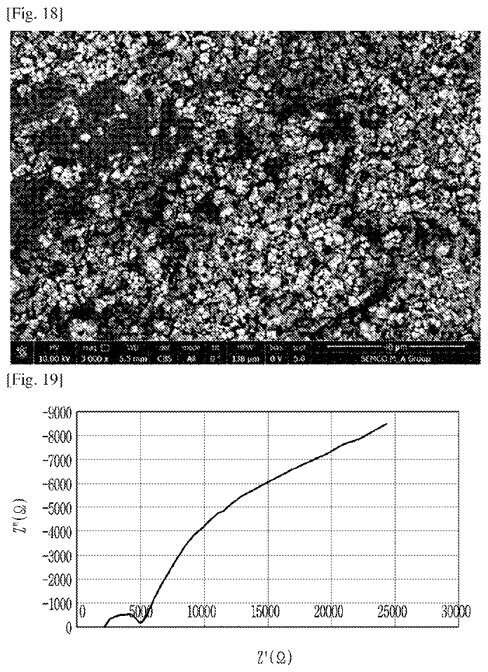

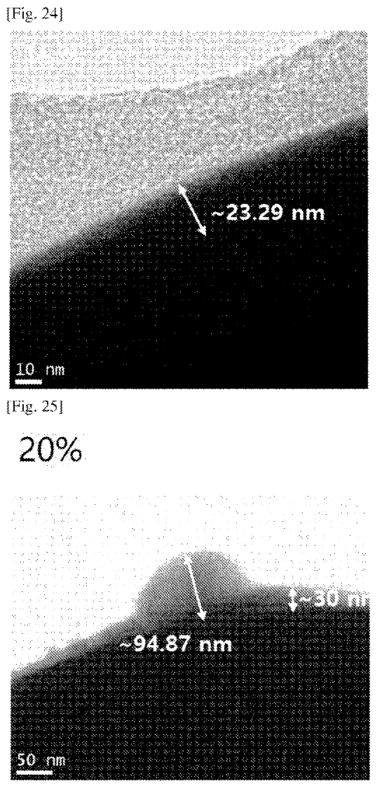

FIGS. 13 to 18 show scanning electron microscope (SEM) photographs of the positive electrode layer taken at 10K and 3K in the cell stacks prepared in Example 1. Example 2, and Comparative Example 6. Compared with Examples 1 and 2. Comparative Example 6 use a sintering aid in an excessively large amount, which increases over-agglomeration between sintering aid and electrolyte but reduce interfacial strength between positive electrode active material and solid electrolyte, relatively large voids and grains are generated in the positive electrode layer. FIGS. 23 to 25 show transmission electron microscope (TEM) photographs of the positive electrode active materials included in each positive electrode layer of the cell stacks of Examples 1 and Comparative Example 6. Referring to FIGS. 23 and 24, a positive electrode active material including an appropriate amount of an oxide of a sintering aid shows that a coating layer is uniformly formed on the surface. On the contrary, referring to FIG. 25, a positive electrode active material including an excessive amount of the oxide of the sintering aid has a non-uniform coating layer on the surface due to over-agglomeration.

### Experimental Example 3: Measurement of Lithium Ionic Conductivity

The cell stack of Example 1 is ion-milled or polished to expose the positive electrode layer, and a portion thereof is sampled into a rectangular plate piece. At both of the piece, electrodes made of gold (Au) are formed, preparing a sample. Subsequently, the sample is measured with respect to AC impedance (frequency: 10⁺⁶ Hz to 10⁻¹ Hz, voltage: 100 mV, 1000 mV) by using an impedance measuring device at room temperature (25° C.), and the result is shown in FIG. 19.

Referring to FIG. 19, lithium ionic conductivity of the positive electrode layer is 1×10⁶ [S/cm] or more.

### Experimental Example 4: Analysis of Interfacial Resistance and Interfacial Strength Between Positive Electrode Layer and Solid Electrolyte Layer

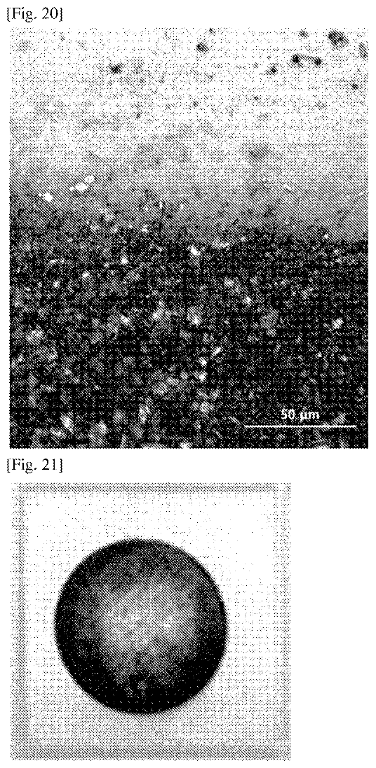

A scanning electron microscope (SEM) photograph of the solid electrolyte layer, the positive electrode layer, and the first solid electrolyte interface layer formed therebetween of the cell stack according to Example 1 is shown in FIG. 20.

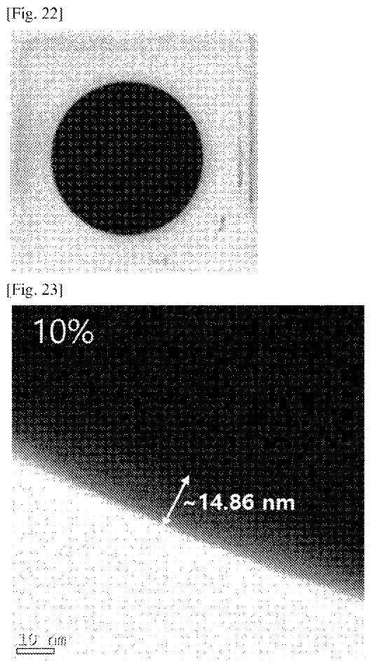

In addition. FIGS. 21 and 22 show photographs of interfacial adhesive strength (strength) of each first solid electrolyte interface layer between positive electrode layer and solid electrolyte layer prepared in Example 1 and Comparative Example 1.

Table 3 shows interfacial resistance of the positive electrode layer and the solid electrolyte layer included in each cell stack of Examples 1 to 2 and Comparative Examples 1 to 6.

The interfacial resistance is measured through EIS (electrochemical impedance spectroscopy) analysis (25° C.).

In addition, the interfacial strengths of each first solid electrolyte interface layer included in the cell stacks manufactured in Examples 1 to 2 and Comparative Examples 1 to 6 are measured and shown in Table 3.

The interfacial strength is to evaluate interfacial adhesive strength between positive electrode layer and solid electrolyte layer by making the positive electrode layer and the solid electrolyte layer into a flexible band on a Li metal substrate and then, pulling it upward, while maintaining 90°, to measure a strength at which this interface is separated.

Referring to Table 3, compared with Comparative Examples 1 to 6, Examples 1 to 2, since a first solid electrolyte interface layer including an oxide of a sintering aid is formed, exhibit very low interfacial resistance of the positive electrode layer and the solid electrolyte layer but very high interfacial strength.

TABLE 3

| | Interfacial | |
|---|---|---|
| | resistance | Interfacial |
| | (impedance | strength |
| | resistance (Ω)) | (MPa) |
| Example 1 | 5,100 | 265 |
| Example 2 | 6,321 | 274 |
| Comparative Example 1 | 100,452 | 182 |
| Comparative Example 2 | 98,683 | 123 |
| Comparative Example 3 | 132,951 | 88 |
| Comparative Example 4 | 169,426 | 92 |
| Comparative Example 5 | 158,457 | 96 |
| Comparative Example 6 | 265,948 | 32 |

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### INDUSTRIAL APPLICABILITY

The present disclosure relates to an all-solid-state battery capable of reducing resistance between an electrode active material in an electrode layer and a solid electrolyte and significantly increasing adhesive strength as well as co-firing them at a low temperature and also, reducing interfacial resistance between electrode layer and solid electrolyte layer and significantly increasing adhesive strength between layers to realize high ionic conductivity and thus applicable to various electrochemical devices and electronic devices.

### DESCRIPTION OF SYMBOLS

100: all-solid-state battery
110: cell stack
111: solid electrolyte layer
112: positive electrode layer
113: negative electrode layer
114: first solid electrolyte interface layer
115: second solid electrolyte interface layer
120, 130: external electrode

1. An all-solid-state battery, comprising:
a solid electrolyte layer; and
a positive electrode layer and a negative electrode layer with the solid electrolyte layer disposed therebetween,
wherein the positive electrode layer includes a positive electrode active material and a solid electrolyte,
the negative electrode layer includes a negative electrode active material and a solid electrolyte,
the positive electrode layer or the negative electrode layer includes an oxide of a sintering aid, and
the solid electrolyte is an amorphous solid electrolyte including a Li (lithium) oxide, a Si (silicon) oxide, a B (boron) oxide, or a combination thereof.

2. The all-solid-state battery of claim 1, wherein
the positive electrode layer includes the positive electrode active material, and a composite including the solid electrolyte and the oxide of the sintering aid on a surface of the positive electrode active material.

3. The all-solid-state battery of claim 1, wherein
the negative electrode layer includes the negative electrode active material, and a composite including the solid electrolyte and the oxide of the sintering aid on a surface of the negative electrode active material.

4. The all-solid-state battery of claim 1, further comprising:
a first solid electrolyte interface layer between the solid electrolyte layer and the positive electrode layer, or
a second solid electrolyte interface layer between the solid electrolyte layer and the negative electrode layer,
wherein the first solid electrolyte interface layer or the second solid electrolyte interface layer includes an oxide of the sintering aid and the solid electrolyte.

5. The all-solid-state battery of claim 1, wherein
the amorphous solid electrolyte includes Li₂O—SiO₂—B₂O₃.

6. The all-solid-state battery of claim 1, wherein
the oxide of the sintering aid includes Li₂O (lithium oxide).

7. The all-solid-state battery of claim 1, wherein
the oxide of the sintering aid included in one of the positive electrode layer or the negative electrode layer is in an amount of 1 to 15 wt % based on the total amount of the one of the positive electrode layer or the negative electrode layer.

8. The all-solid-state battery of claim 1, wherein
the positive electrode active material includes LiCoO₂.

9. The all-solid-state battery of claim 1, wherein
the negative electrode active material includes graphite.

10. The all-solid-state battery of claim 1, wherein
the solid electrolyte layer further includes the oxide of the sintering aid.

11. A method for manufacturing an all-solid-state battery, comprising
(1) preparing a positive electrode mixture of a positive electrode active material, a solid electrolyte, and a sintering aid, and a negative electrode mixture of a negative electrode active material, a solid electrolyte and a sintering aid;
(2) molding the positive electrode mixture and negative electrode mixture to manufacture a positive electrode green sheet and a negative electrode green sheet;
(3) sequentially stacking the positive electrode green sheet, a solid electrolyte green sheet, and the negative electrode green sheet to manufacture a stack; and
(4) co-firing the stack at 450 to 500° C.

12. The method of claim 11, wherein
the solid electrolyte is an amorphous solid electrolyte including a Li (lithium) oxide, a Si (silicon) oxide, a B (boron) oxide, or a combination thereof.

13. The method of claim 12, wherein
the amorphous solid electrolyte includes Li₂O—SiO₂—B₂O₃.

14. The method of claim 11, wherein
the sintering aid includes LiOH (lithium hydroxide).

15. The method of claim 11, wherein
the sintering aid included in one of the positive electrode mixture or the negative electrode mixture is in an amount of 1 to 15 wt % based on the total weight of the one of the positive electrode mixture or the negative electrode mixture.

16. The method of claim 11, wherein
a density of the sintering aid is 1.2 to 1.6 g/L.

17. The method of claim 11, wherein
a melting point of the sintering aid is 450 to 500° C.

18. The method of claim 11, wherein
the positive electrode layer or the negative electrode layer is formed to include an oxide of the sintering aid.

19. The method of claim 18, wherein
the oxide of the sintering aid includes Li₂O (lithium oxide).
